(19) United States
(12) Patent Application Publication
(10) Pub. No.: US 2024/0143221 A1
(43) Pub. Date: May 2, 2024

(54) LOCATE AHEAD ON TAPE DRIVE

(71) Applicant: International Business Machines Corporation, Armonk, NY (US)

(72) Inventors: Atsushi Abe, Ebina (JP); Tohru Hasegawa, Tokyo (JP); Shinsuke Mitsuma, Machida-shi (JP); Hiroshi Itagaki, Yokohama-shi (JP); Tsuyoshi Miyamura, Yokohama-shi (JP); Noriko Yamamoto, Tokyo (JP)

(21) Appl. No.: 18/050,625

(22) Filed: Oct. 28, 2022

(51) Int. Cl. G06F 3/06

(52) U.S. Cl. CPC G06F 3/0656; G06F 3/0611; G06F 3/0659; G06F 3/0682

(57) ABSTRACT

A computer implemented method includes executing a read-ahead operation by reading data from a tape according to a read plan and storing said data in a ring buffer, determining whether the ring buffer is full, receiving a command indicating an area to be read according to the read plan, and, responsive to receiving the command, reading data from an area of the list of areas to be read corresponding to the command from the ring buffer. The method may further include executing additional read-ahead operations until the ring buffer is full. A computer program product and computer system corresponding to the method are also disclosed.

### BACKGROUND

The present invention relates generally to the field of tape drive implementations, and more specifically to locating ahead on a tape drive.

In a linear tape drive, data is written while the tape is moved in the longitudinal direction. In the first write operation, data is written from the beginning of the tape to the end of the tape, and at the end of the tape, the head position is shifted horizontally, and the operation is repeated from the end of the tape to the beginning of the tape. In this operation, a single write from the beginning of the tape to the end of the tape, or a single data stream from the end of the tape to the beginning of the tape, is called a wrap. The tape is divided into four areas in the horizontal direction, and each area is called a data band.

On a tape drive, data is generally assumed to be read in order from the logical beginning of the tape to the logical end of the data. An internal ring buffer therefore exists inside the drive to store the data read from the tape. The tape drive reads the data ahead of the position of the data being read by the application (or host) current position and stores it in the ring buffer.

### SUMMARY

As disclosed herein, a computer implemented method includes receiving a read plan comprising a list of areas to be read, executing a read-ahead operation by reading data from a tape according to the read plan and storing said data in a ring buffer, determining whether the ring buffer is full, receiving a command indicating an area to be read according to the read plan, and, responsive to receiving the command, reading data from an area of the list of areas to be read corresponding to the command from the ring buffer. The method may further include executing additional read-ahead operations until the ring buffer is full. A computer program product and computer system corresponding to the method are also disclosed.

### BRIEF DESCRIPTION OF THE DRAWINGS

FIG. 1 depicts a ring buffer implementation in accordance with at least one embodiment of the present invention;

FIG. 2 is a functional block diagram of components of a tape drive management system in accordance with at least one embodiment of the present invention;

FIG. 3 is a flowchart depicting a locate ahead method in accordance with at least one embodiment of the present invention;

FIG. 4 is a flowchart depicting a read ahead management method in accordance with at least one embodiment of the present invention; and

FIG. 5 is a block diagram of components of a computing system in accordance with an embodiment of the present invention.

### DETAILED DESCRIPTION

Consider a ring buffer implementation in which the current position seen from the host is record number 100. The tape drive has already completed the data of record number 200, which is ahead of it, in the read buffer. In tape drives which use variable-length records, the number of records cannot necessarily be specifically shown.

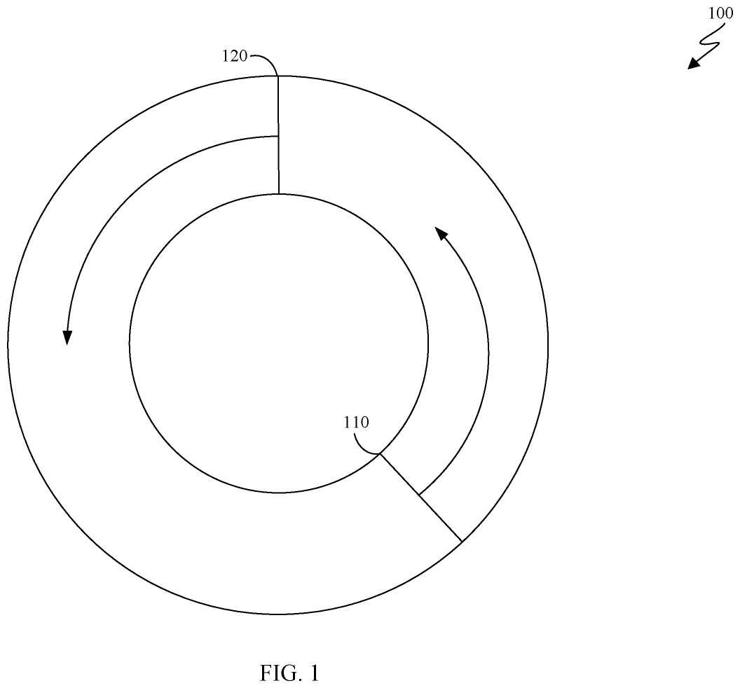

FIG. 1 depicts a ring buffer implementation 100 in accordance with one embodiment of the present invention. As depicted, the ring buffer implementation 100 includes a second position 110 where the tape drive is actively reading, and a first position 120 where the application/host is currently reading. Ring buffer implementation 100 additionally depicts the direction in which the tape drive is reading; as depicted, the tape drive moves from first position 120 to second position 110 in the counterclockwise direction. The tape head continues from second position 110 in the counterclockwise position back towards first position 120, effectively working towards completing the full circle of ring buffer implementation 100. The capacity of ring buffer implementation 100 may be roughly 2 GB with the latest tape drives and may hold two to three seconds of data when reading at maximum speed. In general, control is performed so that when the data reading speed from the host is slow, the ring buffer usage rate is close to 100%, and even when it is not, the buffer is not emptied as much as possible.

In file systems such as linear tape file systems (LTFS), continuous data is accessed repeatedly in smaller units. LTFS has increased in prevalence recently and allows users to access the tapes directly. In such cases, if read-ahead data is held in a ring buffer such as ring buffer implementation 100, reading one file and accessing the next file generates potential waste. First, the ring buffer reads not only the first file it reads, but also the data of the file immediately after it. Second, only when the first file is read and the next file is accessed is the position moved to the beginning of the data in the next file. Embodiments of the present invention improve the read-ahead mechanism implemented in conventional tape drives and improve performance when randomly reading a certain amount of data.

With respect to embodiments of the present invention, the tape drive receives the list of the area to be read in advance (also called an area list) from the host. After reading an area currently being read based on the received area list, the tape drive moves to the beginning of the next area and starts reading data from the tape without waiting for the command to move to the current position (LOCATE command). The tape drive receives an area list from a host and terminates a read ahead when it reaches the end of an area from the list. After terminating the read ahead, the tape drive starts to locate to the next area and makes another read ahead on the next area.

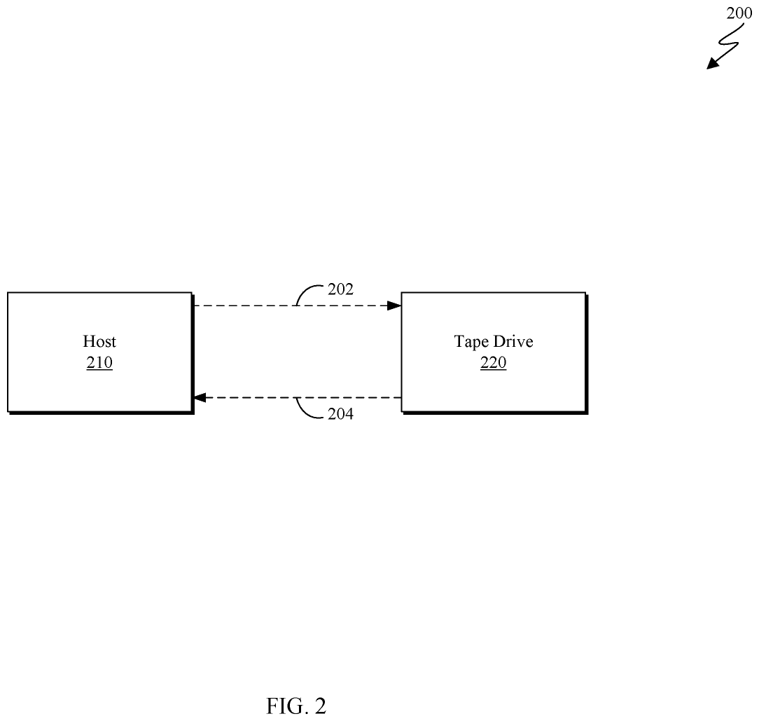

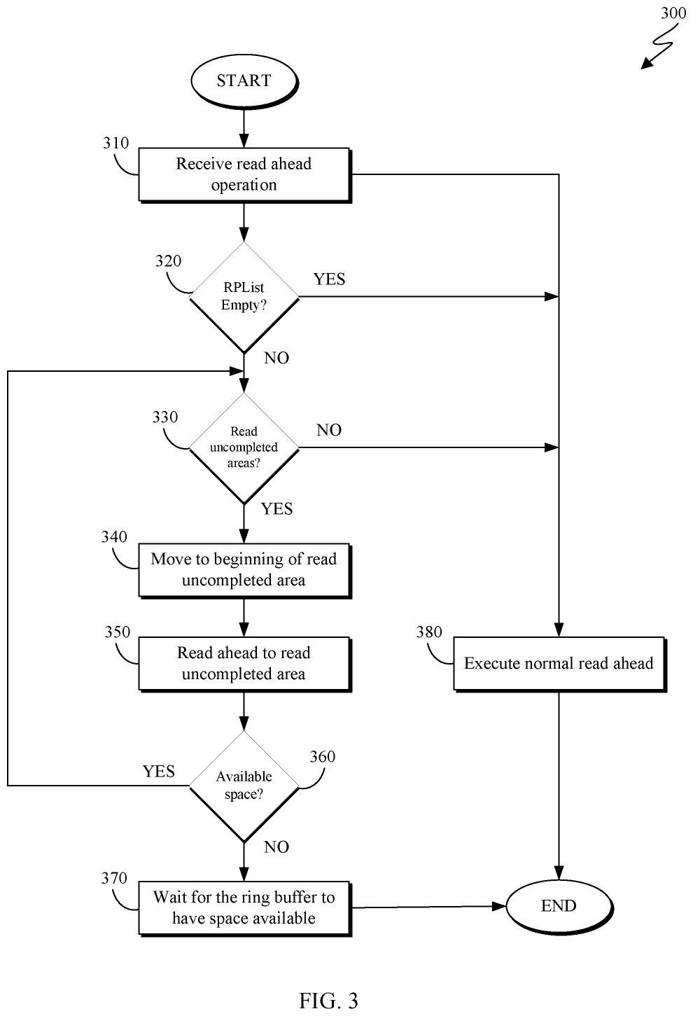

FIG. 2 is a functional block diagram of components of a tape drive management system 200 in accordance with at least one embodiment of the present invention. As depicted, tape drive management system 200 includes a host system 210 and a tape drive 220. In at least some embodiments, tape drive management system 200 is configured to execute a locate ahead method, such as locate ahead method 300 described with respect to FIG. 3. Tape drive management system 200 may enable increased efficiency in read order selection.

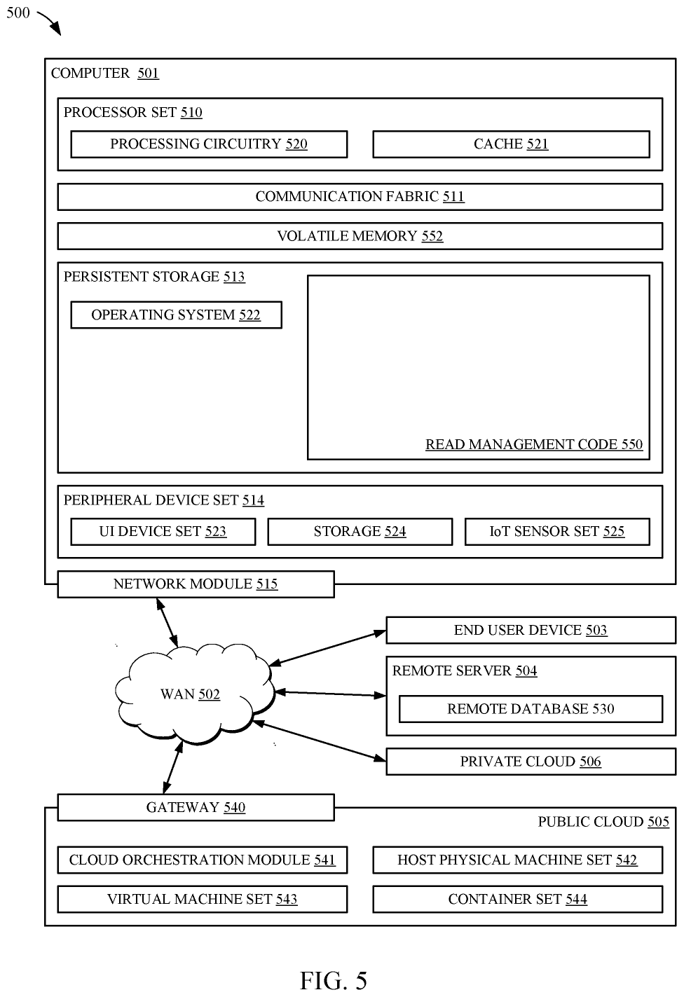

Host system 210 may be a computing system configured to host tape drive 220. While host system 210 and tape drive 220 are pictured separately with respect to FIG. 2, it should be appreciated that tape drive 220 may functionally be a component of host system 210; the separate depiction simply enables increased clarity with respect to the additionally depicted data transfers. Host system 210 can be a desktop computer, a laptop computer, a specialized computer server, or any other computer system known in the art. In some embodiments, host system 210 represents a computer system utilizing clustered computers to act as a single pool of seamless resources. In general, host system 210 is representative of any electronic device, or combination of electronic devices, capable of receiving and transmitting data, as described in greater detail with regard to FIG. 5. Host system 210 may include internal and external hardware components, as depicted and described in further detail with respect to FIG. 5.

Tape drive 220 may be a data storage device that reads and writes data on a magnetic tape. Tape drive 220 may additionally include tape media on which tape drive 220 records and reads data. In general, tape drive 220 is a device capable of reading data stored on a data storage device such as a tape cartridge or other tape media.

While some computation may be achievable using tape drive 220, host system 210 may be configured to take over the computational burden from tape drive 220 when more efficient. In other words, host system 210 may be configured to dedicate available resources if they can execute the necessary computations more quickly than tape drive 220.

As depicted, host system 210 is configured to provide read information 202 to tape drive 220. In at least some embodiments, read information 202 includes a list of areas on a tape to be read. Read information 202 may include at least a first record number and a last record number for each area of the list of areas on the tape to be read. In at least some embodiments, the list of areas included in read information 202 corresponds to areas to be read with respect to a pending read instruction. As depicted, tape drive 220 is configured to provide ring buffer space information 204 to host system 210. Ring buffer space information 204 may include information regarding whether the ring buffer has available free space for additional read ahead data.

FIG. 3 is a flowchart depicting a locate ahead method 300 as executed by a tape drive in accordance with at least one embodiment of the present invention. As depicted, the method includes receiving (310) a read ahead operation request, determining (320) whether the read plan (RP) list is empty, determining (330) whether there are any read-incomplete areas, moving (340) to the beginning of an incomplete read area, reading (350) the area of the incomplete read, determining (360) whether there is available space in the ring buffer, waiting (370) for the ring buffer to have available space, and executing (380) a normal read ahead.

Receiving (310) a read ahead operation request may include receiving a read request. In at least some embodiments, receiving (310) a read ahead operation request includes identifying a read ahead request resultant from the received read request. Receiving (310) a read ahead operation request may include implementing a new command “READ_PLAN” in which the host passes a read start position and end position as operands of the command. Thereby, receiving (310) a read ahead operation request may include receiving a READ_PLAN operation from a host. In general, receiving (310) a read ahead operation includes receiving a request to begin a read operation at a specified location ahead of the current tape drive head. Receiving (310) a read ahead operation request may include recording a read start position and end position (or a number of records) in the internal area list corresponding to the read plan (RP list).

Determining (320) whether the RP list is empty may include analyzing the internal area list. When an entry is first created in the RP list, the drive moves to the read start position of the first entry and begins a read ahead.

Determining (330) whether there are any read-uncompleted areas may include determining whether there are any queued reads which have not been completed. If there are read-uncompleted areas (330, yes branch), the method continues by moving (340) the tape drive to the beginning of the next read-uncompleted area. If there are not read-uncompleted areas (330, no branch) the method continues by executing (380) a normal read ahead.

Moving (340) to the beginning of an uncompleted read area may include moving the tape drive head to the starting position of the read area corresponding to the uncompleted read. Reading (350) the area of the uncompleted read may include reading ahead from the start position of the uncompleted read area to the end position of the uncompleted read area. In at least some embodiments, reading (350) the area of the uncompleted read may include reading from the start position as indicated by the read plan to the end position as indicated by the read plan. In other embodiments, reading (350) the area of the uncompleted read may include reading a number of records indicated by the read plan beginning at the indicated start position.

Determining (360) whether there is available space in the ring buffer may include analyzing the ring buffer to determine how much available space the ring buffer holds. In at least some embodiments, determining (360) whether there is available space in the ring buffer includes determining whether the ring buffer has free space capable of facilitating a next read operation. If there is available space in the ring buffer (360, yes branch), the method continues by returning to reading (330) uncompleted read areas. If there is not available space in the ring buffer (360, no branch), the method continues by waiting (370) for the ring buffer to have space available.

Waiting (370) for the ring buffer to have available space may include waiting until there is available space in the ring buffer to execute a subsequent read operation. In at least some embodiments, waiting (370) for the ring buffer to have available space includes releasing data from the ring buffer for data which has already been read. Once the ring buffer has space, the method returns to read additional uncompleted reads until all areas of the read plan list have been read ahead.

Executing (380) a normal read ahead may include moving a tape drive head to a read start position as indicated by the read ahead and reading either until an end position is reached or until an indicated number of records is met.

In at least some embodiments, locate ahead method 300 includes receiving a read plan comprising a list of areas to be read, executing a read-ahead operation by reading data from a tape according to the read plan and storing said data in a ring buffer, determining whether the ring buffer is full, receiving a LOCATE command according to the read plan, and responsive to receiving the LOCATE command, reading data from an area of the list of areas to be read corresponding to the LOCATE command from the ring buffer.

In at least some embodiments, if the host makes access in a manner disregarding the area and order notified by the read plan, the read plan list is cleared and the drive returns to the normal access mode (the LOCATE command of the drive gives priority to an instruction issued by the host through the LOCATE command even if the drive is currently moving to another position, meaning no special processing is required).

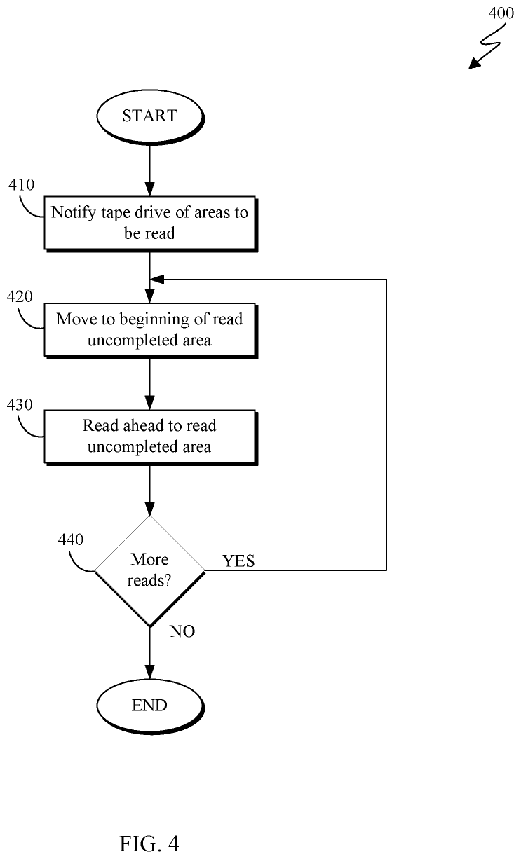

FIG. 4 is a flowchart depicting one embodiment of a read ahead management method 400 in accordance with one embodiment of the present invention. As depicted, read ahead management method includes notifying (410) a tape drive of areas to be read, issuing (420) a LOCATE command to an area of the areas to be read, reading (430) the area, and determining (440) whether additional areas remain. Read ahead management method 400 may enable increased efficiency when managing read ahead methods within tape drives.

Notifying (410) a tape drive of areas to be read may include issuing a READ_PLAN command configured to indicate, to a tape drive, a list of areas to be read. In at least some embodiments, notifying (410) a tape drive of areas to be read includes providing a list of start positions and corresponding end positions. Notifying (410) a tape drive of areas to be read may include providing a list of start positions and a number of records to read beginning with the start positions.

Moving (420) to the beginning of a read uncompleted area may include issuing a LOCATE command to an area of the areas to be read may include issuing a command directing the tape drive to position itself at the start position of an area of the areas to be read. In at least some embodiments, moving (420) to the beginning of a read uncompleted area includes directing the tape drive head to an appropriate start position; in other embodiments, moving (420) to the beginning of a read uncompleted area includes providing the read operation to the tape drive and allowing the drive to determine the appropriate start position accordingly.

Reading (430) the area may include reading ahead from the start position of the read area to the end position of the read area. In at least some embodiments, reading (430) the area may include reading from the start position as indicated by the read plan to the end position as indicated by the read plan. In other embodiments, reading (430) the area may include reading a number of records indicated by the read plan beginning at the indicated start position.

Determining (440) whether additional areas remain may include determining whether the read plan indicates additional areas which need to be read. If there are no additional areas to be read (440, no branch), the method terminates. If there are additional areas to be read, (440, yes branch), the method continues by returning to issuing (420) a LOCATE command to an area of the areas to be read.

Additional embodiments of the above methodology may further include leveraging successive READ commands rather than a LOCATE command to identify multiple areas. In such embodiments, such a READ command would include a corresponding travel time. Embodiments utilizing the READ command may provide increases in performance, while utilizing the LOCATE command may provide simplified location verification. In at least some embodiments, if a LOCATE command is issued in the middle of reading an area, the RP list is discarded, and the normal LOCATE command and read ahead are executed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500, shown in FIG. 5, contains an example of an environment for the execution of at least some of the computer code involved in performing the inventive methods, such as read management code 550. In addition to read management code 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 552, persistent storage 513 (including operating system 522 and read management code 550, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 1. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in read management code 550 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 552 is any type of volatile memory now known or to be developed in the future. Examples include dynamic type random access memory (RAM) or static type RAM. Typically, volatile memory 552 is characterized by random access, but this is not required unless affirmatively indicated. In computer 501, the volatile memory 552 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501) and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

What is claimed is:

1. A computer implemented method comprising:
executing a read-ahead operation by reading data from a tape according to a read plan and storing the data in a ring buffer;
determining whether the ring buffer is full;
receiving a command indicating an area to be read according to the read plan; and
responsive to receiving the command and determining that the ring buffer is not full, reading additional data from an area of the list of areas to be read corresponding to the command from the ring buffer.

2. The computer implemented method of claim 1, wherein one or more areas of the list of areas to be read are indicated by read start positions and read end positions.

3. The computer implemented method of claim 1, wherein one or more areas of the list of areas to be read are indicated by read start positions and a number of records to be read.

4. The computer implemented method of claim 1, wherein the received command includes a LOCATE command.

5. The computer implemented method of claim 1, wherein the received command includes one or more subsequent READ commands.

6. The computer implemented method of claim 5, wherein the one or more subsequent READ commands include an indication of a travel time between positions corresponding to the one or more subsequent READ commands.

7. The computer implemented method of claim 1, further comprising executing additional read-ahead operations until the ring buffer is full.

8. A computer program product comprising:
one or more computer readable storage media and program instructions stored on the one or more computer readable storage media, the program instructions comprising instructions to:
execute a read-ahead operation by reading data from a tape according to a read plan and storing the data in a ring buffer;
determine whether the ring buffer is full;
receive a command indicating an area to be read according to the read plan; and
responsive to receiving the command and determining that the ring buffer is not full, read data from an area of the list of areas to be read corresponding to the command from the ring buffer.

9. The computer program product of claim 8, wherein one or more areas of the list of areas to be read are indicated by read start positions and read end positions.

10. The computer program product of claim 8, wherein one or more areas of the list of areas to be read are indicated by read start positions and a number of records to be read.

11. The computer program product of claim 8, wherein the received command includes a LOCATE command.

12. The computer program product of claim 8, wherein the received command includes one or more subsequent READ commands.

13. The computer program product of claim 12, wherein the one or more subsequent READ commands include an indication of a travel time between positions corresponding to the one or more subsequent READ commands.

14. The computer program product of claim 8, further comprising executing additional read-ahead operations until the ring buffer is full.

15. A computer system comprising:
one or more computer processors;
one or more computer-readable storage media; and
program instructions stored on the computer-readable storage media for execution by at least one of the one or more processors, the program instructions comprising instructions to:
execute a read-ahead operation by reading data from a tape according to a read plan and storing the data in a ring buffer;
determine whether the ring buffer is full;
receive a command indicating an area to be read according to the read plan; and
responsive to receiving the command and determining that the ring buffer is not full, read data from an area of the list of areas to be read corresponding to the command from the ring buffer.

16. The computer system of claim 15, wherein areas of the list of areas to be read are indicated by read start positions and read end positions.

17. The computer system of claim 15, wherein areas of the list of areas to be read are indicated by read start positions and a number of records to be read.

18. The computer system of claim 15, wherein the received command includes a LOCATE command.

19. The computer system of claim 15, wherein the received command includes one or more subsequent READ commands.

20. The computer system of claim 19, wherein the one or more subsequent READ commands include an indication of a travel time between positions corresponding to the one or more subsequent READ commands.
